(19) United States
(12) Patent Application Publication
(10) Pub. No.: US 2004/0076843 A1
(43) Pub. Date: Apr. 22, 2004

(54) Multiple layer films with defined gas permeability and their use as packaging material, especially as cheese maturing packaging

(76) Inventor: Peter Beckmann, Visselhovde (DE)

Correspondence Address: Norris McLaughlin & Marcus, 30th Floor, 220 East 42nd Street, New York, NY, 10017, US

(21) Appl. No.: 10/450,333

(22) PCT Filed: Dec. 12, 2001
(86) PCT No.: PCT/EP01/15489

(30) Foreign Application Priority Data
Dec. 14, 2000 (DE) 100 62 717.0

(51) Int. Cl. B32B 27/28

(52) U.S. Cl. 428/475.2; 428/480

(57) ABSTRACT

The invention relates to multiple layer films, comprising at least one outer seal layer, a <10 μm thick barrier layer consisting of a partially crystalline polyamide mixture of a xylylenediamino adipate and an aliphatic polyamide containing solid, nanoscale fillers as nucleation agents, which for the number-weighted average of all of the dispersed fillers have an extension of ≦10 nm for at least one dimension and an extension of at least 100 nm for another dimension 100 nm; and a plastic support layer, with the exception of a corresponding polyamide layer.

The present invention relates to multilayer films which are not used in the usual way to minimize permeability to water vapor, gases, and aromas, but which have a defined gas permeability and thus permit contents packaged therein to enter into long-lasting, quality-retaining equilibrium with the external environment.

Very many products involved in daily life, and in particular foods and drinks, are produced industrially and packaged in an extremely wide variety of films suitable for retaining the desired properties of the respective contents for the longest possible period of time. The expiry date (ED) here is defined as the day/month/year before which a packaged product is fully satisfactory for use or consumption.

Prior art referred to is Joachim Nentwig: Kunststoff-Folien [Polymer films], Carl-Hanser Verlag 1994, Munich, in relation to polymer films, Dr. Ing. Klaus Stoeckhert: Polyamide, Polyamidfolien und Polyamid-Verbundfolien [Polyamides, polyamide films, and polyamide composite films], Neue Verpackung 8/1984, in relation to polyamide films, H. Wagner und P. Beckmann: Orientierte Polypropylenfolien [Oriented polypropylene films], Neue Verpackung 2/1979, in relation to polypropylene films, and Dipl.-Ing. Hermann Hinsken: Kunststoff-Verbundfolien [Polymer composite films], Neue Verpackung 2/1990 in relation to polymer composite films.

Hot-sealable packaging films are used for producing packaging which is intended for food or drink and which serves for the storage, the distribution, and the hygienic self-service packaging of food or drink, different foods and drinks here placing different requirements upon the gas-permeability of the packaging films to be used.

For example, the packaging of potato chips requires a packaging film impermeable to water vapor, in order to retain crispness. Baguettes or rolls packed under an inert gas atmosphere need gas-tight packaging, so that the inert gas is retained as fungistat, and so that there is no CO₂ loss leading to a pseudovacuum which deforms the product.

Composite films comprising a gas-barrier layer and having oxygen permeability <2.0 cm³/m²×day×bar have proven successful for this purpose.

Particular requirements are also placed upon the industrial packaging of cheese in the form of pieces, slices, or in ground or grated form, in particular when the cheese-maturing process, the duration and intensity of which differs according to type, lasts beyond the moment of packaging, meaning that the cheese continues to mature within the packaging, whereupon hermetically sealed packaging would inflate as a result of evolution of carbon dioxide.

Composite films suitable for this type of packaging are composed of a, where appropriate, printed biaxially oriented polyamide layer (PAB) as backing film with a thickness of 12 or 15 μm, and of olefinic sealable layers of thickness from 35 to 60 μm, the oxygen permeability of which is from 30 to 50 cm³/m²×day×bar. For types of cheese from which gas evolution is particularly marked, or for products known to have a short expiry time, biaxially oriented polyester films (PET) are used instead of PAB backing films, the resultant oxygen permeability being about 90 cm³/m²×day×bar, the increased risk of fracture on creasing being accepted here.

Since biaxially oriented polyamide films are relatively expensive and, in particular when used as a backing film, have disadvantages due to their hygroscopic properties, there is a requirement for replacement packaging material which does not have these disadvantages, for use in the cheese-packaging industry in particular.

It was therefore an object of the present invention to provide a packaging material, in particular packaging films which have defined gas permeability and which are suitable for packaged goods which evolve gases, for example foods and drinks which continue to mature, in particular cheese, and which do not have biaxially oriented polyamide films as backing films, where the entire packaging film is intended to have defined oxygen permeability which depends on the contents, and which is intended to be in the range <100 cm³/m²×day ×bar, particularly preferably in the range from 30 to 50 cm³/m²×day×bar.

According to the invention, this object is achieved by providing a multilayer film which comprises at least

a) one sealable layer as surface layer,

b) a layer with a layer thickness <10 μm and based on a semicrystalline polyamide mixture made from m-xylylenediamine adipate and from an aliphatic polyamide comprising dispersed, solid, anisotropic, nano-scale, nucleating fillers which, when the number average over all of the dispersed fillers is taken, measure not more than 10 nm in one of their dimensions and measure at least 100 nm in at least one other dimension and

c) a backing layer made from plastic, with the exception of a biaxially oriented backing layer made from polyamide.

The total thickness of the multilayer film of the invention is preferably from 30 to 90 μm, particularly preferably from 40 to 70 μm, where the layer b) made from the polyamide mixture comprising the nano-scale particles is [sic] preferably from 2 to 7 μm, particularly preferably from 3 to 5 μm.

The multilayer films of the invention have defined oxygen permeability <100 cm³/m² ×day×bar, preferably in the range from 20 to 60, particularly preferably from 30 to 50, cm³/m² ×day×bar. It was entirely surprising that this could be achieved using the multilayer film structure of the invention comprising the layer b) as barrier layer with a layer thickness below 10 μm, since, in contrast, when using biaxially oriented polyamide backing films, similar oxygen permeability can only be achieved using the greater layer thickness usually used for cheese packaging.

Layer c), the backing layer, may comprise the usual plastics used for producing backing films, preferably polyesters, such as polyethylene terephthalate, or polyolefins, such as polypropylene.

The backing film preferably has biaxial orientation. The backing film is preferably transparent. The layer thickness is preferably from 10 to 25 μm, particularly preferably from 12 to 20 μm. That surface of the backing film facing away from the remainder of the film composite may have a sealable layer, preferably a hot-sealable layer, which may be identical with the sealable layer a).

The sealable layer a) is preferably a hot-sealable layer which forms one surface layer of the multilayer film of the invention. The layer a) is preferably composed of polyolefins, particularly preferably of polyethylene, of polypropylene, of an ethylenepropylene copolymer, of a mixture of polyolefins, of an olefinic terpolymer, of a mixture of the polymers mentioned, very particularly preferably of linear low-density polyethylene (LLDPE), where appropriate mixed with polybutene, or of polyvinyl acetate.

Each of the surfaces of the layer b) of the multilayer film of the invention, which has a layer thickness of <10 μm, preferably a layer thickness of from 2 to 7 μm, has at least one adjacent layer, meaning that the layer b) has no uncovered surface. The layer b) is based on a semicrystalline polyamide mixture made from m-xylylenediamine adipate and from an aliphatic polyamide, and has nano-scale, solid, anisotropic particles dispersed therein and acting as nucleating fillers. The dispersed nucleating fillers are preferably solid, anisotropic particles which, when the number average is taken for all of the dispersed particles, measure not more than 10 nm in at least one freely selectable dimension, preferably for every dispersed particle. It is particularly preferable that the measurement of these particles in at least one other dimension is in the range from at least 100 nm to at most 1,000 nm. Particular preference is given to the use of lamellar particles whose thickness is <10 nm, e.g. phyllosilicates. These may have been selected from the group consisting of phyllosilicates such as magnesium silicate or aluminum silicate, montmorillonite, saponite, beidellite, nontronite, hectorite, stevensite, vermiculite, halloysite, and synthetic analogues of these.

The at least semicrystalline polyamide mixture is preferably composed of, based on the entire mixture of the polyamides, from 60 to 98% by weight, with preference from 65 to 85% by weight, of a semiaromatic polyamide whose structure is composed of m-xylylenediamine and adipic acid and, based on the entire mixture of the polyamides, from 2 to 40% by weight, preferably from 15 to 35% by weight, of an aliphatic polyamide, such as nylon-6, nylon-11, nylon-12, nylon-6,6, nylon-6,10, nylon-6/6,6, particularly preferably nylon-6. The layer b) comprises, based on the aliphatic polyamide component, in each case <10% by weight, preferably from 1 to 5% by weight, of nanoscale, nucleating, solid particles, which are particularly preferably added at an early stage during the preparation of the respective aliphatic polyamide.

For reasons associated with process technology, each surface of the layer b) preferably has a layer a) which has been bonded to the layer b) by way of an adhesion-promoter layer, to increase adhesion. The adhesion-promoter layer is preferably coextruded, and is preferably based on a maleic-anhydride-grafted polyethylene. To bond this composite to the respective backing film c), it is preferable to use a solvent-free polyurethane adhesive as adhesion promoter, preferably applied at a layer thickness below 5 μm.

The backing film may moreover be a pigmented, printed, or unprinted film, and the printing method here may use a gravure printing machine or a flexel [sic] printing machine. The print is preferably not arranged on the external surface.

The multilayer film of the invention may be produced by known techniques, such as adhesive lamination, sandwich coating, or extrusion coating, and the backing film here is preferably combined with the remainder of the film composite produced in a separate step of the process.

This can be produced with the aid of multilayer blown-film, flat-film, or coating or extrusion lamination systems, preference being given here to blown or flat film coextrusion.

The multilayer films of the invention having defined gas permeability, i.e. barrier function, within a certain gas permeability range, give excellent results when printed, since the level of hygroscopic properties of the barrier layer has been minimized, and provide the necessary retention of pattern-repeat distance and register, and in particular in combination with a biaxially oriented polypropylene backing film, has reduced water-vapor permeability and thus reduced loss in weight from a product packaged therein, and the multilayer films of the invention are therefore particularly suitable as packaging material, very particularly preferable as packaging material for foods or drinks which evolve gases, e.g. cheese.

The present invention therefore also provides the use of the multilayer films of the invention as a packaging material, preferably for foods or drinks which evolve gases, in particular as a packaging material for cheese.

The present invention also provides a packaging made from a multilayer film of the invention for foods or drinks which evolve gases, preferably cheese, very particularly preferably a packaging for maturing cheese. This packaging may be produced on either horizontal or vertical automatic packaging machines with the aid of the multilayer films of the invention.

Test Methods

Oxygen permeability is determined in accordance with the draft of DIN 53380, Part 3, July 1989 issue, using the carrier gas method. It is defined as the Nm1 quantity of oxygen which diffuses in 24 hours through one square meter of film under a pressure difference of one bar at a prescribed temperature and humidity. It is measured using the Oxtran 100 device from Mocon Instrument [sic]. Unless otherwise specified, oxygen permeability is stated in cm³/m²*d*bar at 23° C. and 75% relative humidity (d=day).

The haze stated is the quantity of light in % which is reemitted in the form of scattered light after the film has been illuminated by a central beam, based on the entire amount of transmitted light. The test uses Procedure A of the ASTM test standard D 1003-61.

The seal strength determined is the force in N, based on the test strip width of 15 mm, required to split a seal seam produced under defined conditions (pressure, temperature, time).

Sealing conditions: pressure 5 N/cm2 [sic], time 0.5 sec, temperature from 105 to 170° C., in steps of five Kelvin.

Test equipment: Brugger sealer

Test strip cutter with cutting width 15 mm tensile strength testing machine with measurement range 10 N and separation velocity 100 mm/min.

### EXAMPLES

All of the substances mentioned are commercially available traded products.

### Example 1

An 8-layer blown-film extruder is used to coextrude a mixture of, based on the entire mixture of the polyamides, 80% by weight of a polyamide composed of mxylylenediamine and adipic acid (PA MXD6) and, based on the entire mixture of the polyamides, 20% by weight of nylon-6 which, based on nylon-6, [lacuna] 2% by weight of a lamellar aluminum phyllosilicate as a central layer b) of thickness 4 μm embedded between, in each case, an adhesion-promoter layer and a layer a) composed of linear low-density polyethylene. The melt temperature was 270° C., and the expansion ratio for the coextruded blown film was 1:1.6.

The resultant blown film, separated to give two webs, electrically pre-treated on one side and wound up, was laminated on a commercially available laminating system, using a solvent-free polyurethane adhesive (Primacor 1410 from DOW) to a polyethylene terephthalate (PET) backing film with a thickness of 12 μm or to a biaxially oriented polypropylene (BOPP) backing film with a layer thickness of 15 μm or to a polypropylene backing film coextruded with a sealable layer composed of polyethylene and biaxially stretched, with a thickness of 20 μm.

The methods stated above were used to determine the oxygen permeability, the haze, and the seal strength of the resultant multilayer films of the invention. The appropriate values can be found in Table 1 below.

Structure of Blown Film A

| | | | | |
|---|---|---|---|---|
| LLDPE | Adhesion | 80% by weight of | Adhesion | LLDPE |
| 15μ | promoter | PA MXD 6*, | promoter | 23 μm |
| | 4 μm | 20% by weight of nylon-6 | 4 μm | |
| | | with 2% by weight of | | |
| | | nanoparticles ** 4 μm | | |

*MXD 6-6121, Mitsubishi
** Nanoparticles of aluminium silicate
LLDPE = linear low-density polyethylene

TABLE 1

| Backing | Blown | Oxygen | | Seal | |
|---|---|---|---|---|---|
| film | film | perm. | Haze | str. | |
| PET 12 μm | A | 37 | 7 | 23 | + |
| BOPP 15 μm | A | 42 | 8 | 25 | + |
| Coex BOPP | A | 44 | 9 | 26 | + |
| 20 μm | | | | | |

+ suitable for cheese packaging in any form
PET = polyethylene terephthalate
BOPP = biaxially oriented polypropylene
Coex Bopp = biaxially oriented coextrudate with a hot-sealable polyethylene layer of thickness 5 μm

### Comparative Example 1

The type of commercially available packaging film usually used for cheese packaging, composed of biaxially oriented polyamide (PAB) and of a sealable layer composed of linear low-density polyethylene exhibits the values stated in Table 2 for oxygen permeability, haze, and seal strength, these having been determined by the methods stated above.

TABLE 2

| Backing | Sealable | Oxygen | | Seal |
|---|---|---|---|---|
| film | layer | perm. | Haze | str. |
| PAB 15 μm | LLDPE | 42 | 8 | 32 |
| | 50 μm | | | |

suitable for cheese packaging in any form

1. A multilayer film comprising
a) at least one sealable layer as surface layer,
b) a layer with a layer thickness <10 μm and based on a semicrystalline polyamide mixture made from m-xylylenediamine adipate and from an aliphatic polyamide comprising dispersed, solid, anisotropic, nano-scale, nucleating fillers which, when the number average over all of the dispersed fillers is taken, measure not more than 10 nm in one of their dimensions and measure at least 100 nm in at least one other dimension and
c) a backing layer made from plastic, with the exception of a biaxially oriented backing layer made from polyamide.

2. The multilayer film as claimed in claim 1, characterized in that the thickness of the layer b) is in the range from 2 to 7 μm, preferably from 3 to 5 μm.

3. The multilayer film as claimed in claim 1 or 2, which has oxygen permeability of <100 cm³/m²×day ×bar, preferably from 20 to 60 cm³/m²×day×bar.

4. The multilayer film as claimed in any of claims 1 to 3, characterized in that the sealable layer a) is composed of a polyvinyl acetate, of a polyolefin, preferably of polyethylene, of polypropylene, of an ethylene-propylene copolymer, of an olefinic terpolymer, of a mixture of polyolefins, particularly preferably of a linear low-density polyethylene (LLDPE).

5. The multilayer film as claimed in any of claims 1 to 4, characterized in that the layer b) is composed of a polyamide mixture made from, based on the entire mixture of the polyamides, from 60 to 98% by weight, preferably from 65 to 85% by weight, of m-xylylenediamine adipate, and, based on the entire mixture of the polyamides, from 2 to 40% by weight, preferably from 15 to 35% by weight, of an aliphatic polyamide, preferably nylon-6, and ≦10% by weight, preferably from 1 to 5% by weight, based on the aliphatic polyamide component, of the nano-scale fillers.

6. The multilayer film as claimed in any of claims 1 to 5, characterized in that the nano-scale fillers are lamellar.

7. The multilayer film as claimed in claim 6, characterized in that the fillers are composed of natural or synthetic phyllosilicates.

8. The multilayer film as claimed in any of claims 1 to 7, characterized in that the aliphatic polyamide has been prepared in the presence of the dispersed, nano-scale fillers.

9. The multilayer film as claimed in any of claims 1 to 8, characterized in that the layer c) is composed of polyester, preferably polyethylene terephthalate, or a polyolefin, preferably polypropylene.

10. The multilayer film as claimed in any of claims 1 to 9, characterized in that the backing layer has biaxial orientation.

11. The multilayer film as claimed in any of claims 1 to 10, characterized in that each of the surfaces of the layer b) has been bonded to a layer a), in each case by way of an adhesion-promoter layer.

12. The multilayer film as claimed in any of claims 1 to 11, characterized in that the total thickness of the film is in the range from 30 to 90 μm.

13. The use of the multilayer film as claimed in any of claims 1 to 12 as, or in, packaging material, preferably as, or in, packaging films.

14. A cheese-maturing packaging made from the multi-layer film as claimed in any of claims 1 to 12.
